(19) United States
(12) Patent Application Publication
(10) Pub. No.: US 2010/0241408 A1
(43) Pub. Date: Sep. 23, 2010

(54) METHOD AND SYSTEM FOR TESTING COMPLIANCE OF A DEFINED DOMAIN WITH A MODEL

(75) Inventors: Stephen Edward Ditlinger, San Dimas, CA (US); Boi Nghia Tran, Tustin, CA (US)

Correspondence Address: LAW OFFICE OF DONALD D. MONDUL, PO BOX 1203, 354 MOOSE LANE, SEELY LAKE, MT, 59868-1203, US

(73) Assignee: BOEING COMPANY, A CORPORATION OF DELAWARE, Chicago, IL (US)

(21) Appl. No.: 12/408,497

(22) Filed: Mar. 20, 2009

(51) Int. Cl. G06G 7/48

(52) U.S. Cl. 703/6

(57) ABSTRACT

Method for testing compliance of a defined domain with reference model criteria includes: (a) providing an architecture file describing the domain; (b) specifying formatted files relating to the architecture file; (c) parsing the formatted files to ascertain model data elements; (d) structuring model data elements for use with a criteria subset associated with a simulation scenario; (e) effecting simulation using the model data elements in the simulation scenario according to the criteria subset; and (f) evaluating compliance of the model data elements according to evaluation parameters.

### TECHNICAL FIELD

The present disclosure is directed to a method and system for ascertaining compliance of an architecture with a reference model, and especially to an automated method and system for ascertaining compliance of an architecture with a reference model.

### BACKGROUND

Management of large organizations employing sophisticated systems and technologies in pursuit of joint objectives may require a structured, repeatable method for evaluating investments and investment alternatives relating to the organization. Additionally, the ability to effectively implement organization change, create new systems and deploy new technologies may require such a structured, repeatable method and system for evaluating investments in the organization. Developing and implementing an architecture based upon common denominators across an organization may permit architecture descriptions to be compared and related across programs and objective areas. Such a common denominator-based architecture may establish a foundation for analysis that supports decision making processes throughout the organization.

Underlying an architecture and tools employed within the architecture may be a common specification of data planned to be incorporated in architecture data repositories and data bases. Such a specification may be embodied in a reference model established by predetermined criteria implementing the common architecture.

Manually checking compliance of a defined domain, such as a program or an investment, with a reference model implementing a common architecture may be subjective, tedious, time-consuming and prone to errors. There is a need for an automatic method and system for improved objectively testing compliance of a defined domain with a reference model established by predetermined criteria implementing a common architecture.

### SUMMARY

In one embodiment of the invention, a method for testing compliance of a defined domain with reference model criteria includes: (a) providing an architecture file describing the domain; (b) specifying formatted files relating to the architecture file; (c) parsing the formatted files to ascertain model data elements; (d) structuring model data elements for use with a criteria subset associated with a simulation scenario; (e) effecting simulation using the model data elements in the simulation scenario according to the criteria subset; and (f) evaluating compliance of the model data elements according to evaluation parameters; An embodiment may further include, if the model data elements do not comply with the evaluation parameters, altering model data element(s) and repeating a subset of the evaluation steps.

In another embodiment of the invention, a system for testing compliance of a defined domain with a reference model established by predetermined criteria implementing a common architecture includes: (a) a user interface unit; the user interface unit being configured for receiving an architecture data file substantially describing the defined domain; the user interface unit being further configured for a user to specify a first plurality of formatted files relating to the architecture data file in a predetermined format; (b) a parsing unit coupled with the user interface unit; the parsing unit being configured for employing selected formatted files of the first plurality of formatted files to ascertain a plurality of model data elements; (c) a mapping unit coupled with the parsing unit; the mapping unit identifying selected model data elements of the plurality of model data elements; the mapping unit structuring the selected model data elements for use in connection with a criteria subset of the predetermined criteria; (d) a simulating unit coupled with the mapping unit; the simulating unit associating the criteria subset with a simulation scenario; the simulating unit effecting a simulation using the selected model data elements in connection with the simulation scenario according to the criteria subset; and (e) an evaluating unit coupled with the simulating unit; the evaluating unit effecting evaluation of compliance of the selected model data elements in connection with the simulation scenario according to the criteria subset according to a plurality of predetermined evaluation parameters; the evaluating unit presenting at least one evaluation conclusion indicating the compliance; An embodiment may further include: (f) a decision unit coupled with the evaluating unit coupled with the user interface unit; and (g) an adjustment unit coupled with the decision unit. If the selected model data elements do not satisfactorily comply with the plurality of predetermined evaluation parameters, the decision unit is configured to cooperate with the adjustment unit to effect adjusting at least one model data element of the selected model data elements and readying the system for another iteration of the evaluation using the adjusted at least one model data element.

It is, therefore, a feature of the present disclosure to provide an automatic method and system for improved objectively testing compliance of a defined domain with a reference model established by predetermined criteria implementing a common architecture.

Further features of the present disclosure will be apparent from the following specification and claims when considered in connection with the accompanying drawings, in which like elements are labeled using like reference numerals in the various figures, illustrating the preferred embodiments of the disclosure.

### BRIEF DESCRIPTION OF THE DRAWINGS

FIG. 1 is a schematic diagram illustrating a system for testing compliance of a defined domain with a reference model established by predetermined criteria implementing a common architecture in an advantageous embodiment of the invention.

FIG. 2 is a flow diagram illustrating a method for testing compliance of a defined domain with a reference model established by predetermined criteria implementing a common architecture in an advantageous embodiment of the invention.

### DETAILED DESCRIPTION

An example of an architecture framework with which the present disclosure may be advantageously employed may be found in unclassified Department of Defense (DoD) documents: (1) “DoD architecture Framework Version 1.5”; Volumes 1-3 of 23 Apr. 2007; and (2) “Technical Specifications for the Core Architecture Data Model (CADM) Version 1.5”: 23 Apr. 2007.

The terms “coupled” and “connected”, along with their derivatives, may be used herein. It should be understood that these terms are not intended as synonyms for each other. Rather, in particular embodiments, “connected” may be used to indicate that two or more elements are in direct physical or electrical contact with each other. “Coupled” may be used to indicated that two or more elements are in either direct or indirect (with other intervening elements between them) physical or electrical contact with each other, or that the two or more elements co-operate or interact with each other (e.g. as in a cause and effect relationship).

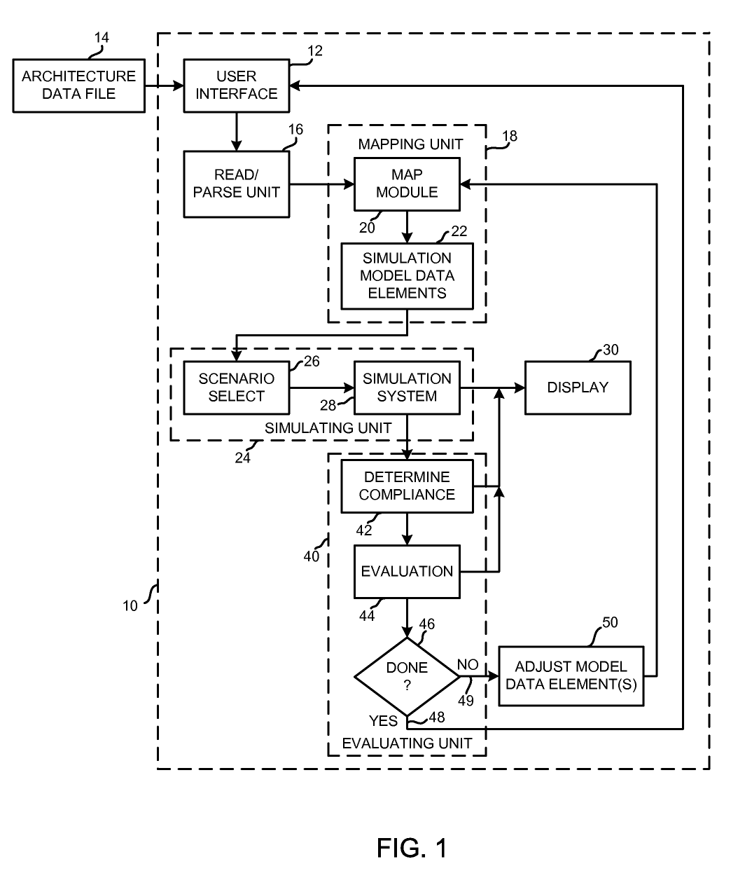

FIG. 1 is a schematic diagram illustrating a system for testing compliance of a defined domain with a reference model established by predetermined criteria implementing a common architecture. For example, a reference model may be a core architecture data model (CADM) with predetermined criteria relating to one or more measures of effectiveness such as, but not limited to, performance, safety, operability, reliability, workload, security, and human performance requirements. In FIG. 1, a system 10 includes a user interface 12 configured and coupled for receiving data from an architecture data file 14. Architecture data file 14 may substantially describe a defined domain being compared with a reference model that may be established by predetermined criteria implementing a common architecture. User interface 12 may be employed for specifying a first plurality of formatted files relating to data received from architecture data file 14. The first plurality of formatted files may be configured in a predetermined format. For example, the first plurality of formatted files may be eXtensible Markup Language files.

A parsing unit 16 may be coupled with user interface 12 for receiving selected formatted files of the first plurality of formatted files. Parsing unit 16 may parse or resolve into component parts the selected formatted files to ascertain a plurality of model data elements that may be identified in the model implementing the architecture of the defined domain. A mapping unit 18 may be coupled with parsing unit 16. Mapping unit 18 may include, by way of example and not by way of limitation, a map module 20 coupled with parsing unit 16 and a simulation model data elements unit 22 coupled with map module 20. Map module 20 and simulation model data elements unit 22 may cooperate to receive selected model data elements from parsing unit 16 and structure the selected model data elements for use in connection with one or more criteria subset of the predetermined criteria that establish the reference model to align a respective criteria subset with each of one or more simulation scenarios.

A simulating unit 24 may be coupled with mapping unit 18. Simulating unit 24 may include, by way of example and not by way of limitation, a scenario select unit 26 coupled with mapping unit 18 and a simulation system 28 coupled with scenario select unit 26. Scenario select unit 26 and simulation system 28 may cooperate to effect a simulation using the selected model data elements in connection with a selected simulation scenario received from mapping unit 18 according to the criteria subset received from mapping unit 18.

A display unit 30 may be coupled with simulating unit 24 to present information relating to the simulation or other operations of system 10 to a user.

An evaluating unit 40 may be coupled with simulating unit 24. Evaluating unit 40 may include, by way of example and not by way of limitation, a compliance determining unit 42 coupled with simulation system 28, an evaluation unit 44 coupled with compliance determining unit 42 and a decision unit 46 coupled with evaluation unit 44. One or both of compliance determining unit 42 and evaluation unit 44 may be coupled with display unit 30. Compliance determining unit 42 and evaluation unit 44 may cooperate to effect evaluation of compliance of the selected model data elements in connection with the simulation scenario effected by simulating unit 24 according to the criteria subset and a plurality of evaluation parameters. If the selected model data elements satisfactorily comply with the predetermined evaluation parameters, decision unit 46 may advise user interface 12 via a YES response port 48 to ready for another evaluation involving a next plurality of formatted files.

A model data element adjustment unit 50 may be coupled with a NO response port 49 of decision unit 46. If the selected model data elements do not satisfactorily comply with the predetermined evaluation parameters, the selected model data elements used in the simulation effected by simulating unit 24 may be passed to model data element adjustment unit 50 from decision unit 46 via NO response port 49. Model data element adjustment unit 50 may adjust or alter one or more model data element and provide at least the one or more altered model data element to mapping unit 18 for use in a following iterative simulation.

In a preferred embodiment, after receiving selected formatted files of the first plurality of formatted files, parser unit 16, mapping unit 18, simulating unit 24, compliance determining unit 42 and evaluation unit 44 may operate automatically to effect evaluation of compliance of the currently selected model data elements without requiring further input by a user. In other embodiments, the iterative simulation previously described may be fully automated where model data elements are automatically adjusted and input to mapping unit 18 for additional iterative simulations to find the architectural parameter space that meets the predetermined evaluation parameters.

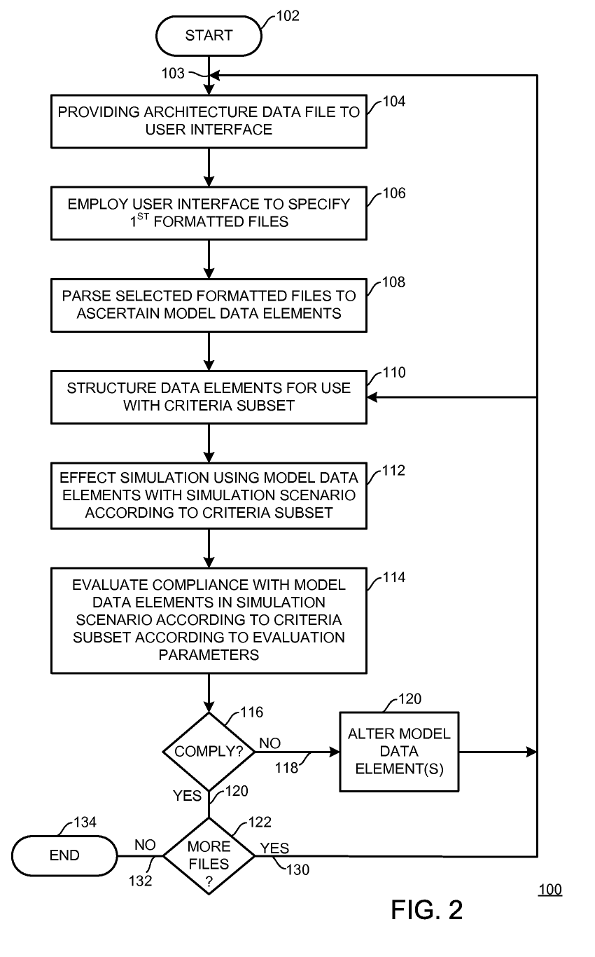

FIG. 2 is a flow diagram illustrating a method for testing compliance of a defined domain with a reference model established by predetermined criteria implementing a common architecture. In FIG. 2, a method 100 for testing compliance of a defined domain with a reference model may begin at a START locus 102. The reference model may be established by predetermined criteria implementing a common architecture employable throughout an organization.

Method 100 may continue with providing an architecture data file to a user interface, as indicated by a block 104. The architecture data file may substantially describe the defined domain.

Method 100 may continue with employing the user interface to specify a first plurality of formatted files relating to the architecture data file in a predetermined format, as indicated by a block 106.

Method 100 may continue with parsing selected formatted files of the first plurality of formatted files to ascertain a plurality of model data elements, as indicated by a block 108. Parsing may effect resolving into component parts the selected formatted files to ascertain a plurality of model data elements that may be identified in the model implementing the architecture of the defined domain. Parsing may also include allowing a user to provide additional model data elements to the plurality of model data elements.

Method 100 may continue with structuring selected model data elements of the plurality of model data elements for use in connection with a criteria subset of the predetermined criteria, as indicated by a block 110. The criteria subset may be associated with a simulation scenario.

Method 100 may continue with effecting a simulation using the selected model data elements in connection with the simulation scenario according to the criteria subset, as indicated by a block 112.

Method 100 may continue with evaluating compliance of the selected model data elements in connection with the simulation scenario according to the criteria subset according to a plurality of predetermined evaluation parameters, as indicated by a block 114.

Method 100 may continue with posing a query whether the selected model data elements satisfactorily comply with the plurality of predetermined evaluation parameters, as indicated by a query block 116.

If the selected model data elements do not satisfactorily comply with the plurality of predetermined evaluation parameters, method 100 may proceed from query block 116 via a NO response line 118. Method 100 may continue with altering at least one model data element of the selected model data elements, as indicated by a block 120. Method 100 may continue to a locus 103 and prepare for another evaluation involving an altered plurality of formatted files. In other embodiments, the method may involve automatically perform an iterative evaluation using currently selected formatted files and the altered model data elements and continue at locus 110.

If the selected model data elements satisfactorily comply with the plurality of predetermined evaluation parameters, method 100 may proceed from query block 116 via a YES response line 120 and a query may be posed whether more formatted files are to be employed in an evaluation, as indicated by a query block 122.

If more formatted files are to be employed in an evaluation, method 100 may proceed from query block 122 via a YES response line 130 to locus 103 and prepare for another evaluation involving a next plurality of formatted files. Method 100 may thereafter repeat steps indicated by blocks 104, 106, 108, 110, 112, 114, 116, 120, 122 employing a next plurality of formatted files.

If more formatted files are not to be employed in an evaluation, method 100 may proceed from query block 122 via a NO response line 132 to an END locus 134. Method 100 may terminate at END locus 134.

It is to be understood that, while the detailed drawings and specific examples given describe preferred embodiments of the disclosure, they are for the purpose of illustration only, that the system and method of the disclosure are not limited to the precise details and conditions disclosed and that various changes may be made therein without departing from the spirit of the disclosure which is defined by the following claims:

I claim:

1. A method for testing compliance of a defined domain with a reference model; said reference model being established by predetermined criteria implementing a common architecture; the method comprising:
(a) providing an architecture data file to a user interface; said architecture data file substantially describing said defined domain;
(b) employing said user interface to specify a first plurality of formatted files relating to said architecture data file in a predetermined format;
(c) parsing selected formatted files of said first plurality of formatted files to ascertain a plurality of model data elements;
(d) structuring selected model data elements of said plurality of model data elements for use in connection with a criteria subset of said predetermined criteria; said criteria subset being associated with a simulation scenario;
(e) effecting a simulation using said selected model data elements in connection with said simulation scenario according to said criteria subset; and
(f) evaluating compliance of said selected model data elements in connection with said simulation scenario according to said criteria subset according to a plurality of predetermined evaluation parameters

2. The method of claim 1 further comprising if said selected model data elements do not satisfactorily comply with said plurality of predetermined evaluation parameters, altering at least one model data element of said selected model data elements and repeating steps (b) through (f) specifying a next plurality of formatted files.

3. The method of claim 1 further comprising if said selected model data elements do not satisfactorily comply with said plurality of predetermined evaluation parameters, altering at least one model data element of said selected model data elements and repeating steps (d) through (f).

4. The method for testing compliance of a defined domain with a reference model as recited in claim 1 wherein said first plurality of formatted files are extensible Markup Language files.

5. The method for testing compliance of a defined domain with a reference model as recited in claim 1 wherein said reference model is a core architecture data model.

6. The method for testing compliance of a defined domain with a reference model as recited in claim 1 wherein said parsing step may permit a user to provide additional model data elements to said plurality of model data elements.

7. The method for testing compliance of a defined domain with a reference model as recited in claim 1 wherein said predetermined criteria is at least one of performance, safety, operability, reliability, workload, security, and human performance requirements.

8. The method for testing compliance of a defined domain with a reference model as recited in claim 1 wherein steps (c) to (f) are performed automatically.

9. The method for testing compliance of a defined domain with a reference model as recited in claim 3 wherein said altering said at least one model data element is performed automatically.

10. A system for testing compliance of a defined domain with a reference model; said reference model being established by predetermined criteria implementing a common architecture; the system comprising:
(a) a user interface unit; said user interface unit being configured for receiving an architecture data file substantially describing said defined domain; said user interface unit being further configured for a user to specify a first plurality of formatted files relating to said architecture data file in a predetermined format;
(b) a parsing unit coupled with said user interface unit; said parsing unit being configured for employing selected formatted files of said first plurality of formatted files to ascertain a plurality of model data elements;
(c) a mapping unit coupled with said parsing unit; said mapping unit identifying selected model data elements of said plurality of model data elements; said mapping unit structuring said selected model data elements for use in connection with a criteria subset of said predetermined criteria;
(d) a simulating unit coupled with said mapping unit; said simulating unit associating said criteria subset with a simulation scenario; said simulating unit effecting a simulation using said selected model data elements in connection with said simulation scenario according to said criteria subset; and
(e) an evaluating unit coupled with said simulating unit; said evaluating unit effecting evaluation of compliance of said selected model data elements in connection with said simulation scenario according to said criteria subset according to a plurality of predetermined evaluation parameters; said evaluating unit presenting at least one evaluation conclusion indicating said compliance.

11. The system for testing compliance of a defined domain with a reference model as recited in claim 10 further comprising:
a decision unit coupled with said evaluating unit coupled with said user interface unit; and
an adjustment unit coupled with said decision unit;
wherein if said selected model data elements do not satisfactorily comply with said plurality of predetermined evaluation parameters, said decision unit cooperating with said adjustment unit is configured to effect adjusting at least one model data element of said selected model data elements and readying the system for another iteration of the evaluation using said adjusted at least one model data element.

12. The system for testing compliance of a defined domain with a reference model as recited in claim 10 wherein said first plurality of formatted files are extensible Markup Language files.

13. The system for testing compliance of a defined domain with a reference model as recited in claim 10 wherein said reference model is a core architecture data model.

14. The system for testing compliance of a defined domain with a reference model as recited in claim 10 wherein said parsing unit is configured to permit a user to provide additional model data elements to said plurality of model data elements.

15. The system for testing compliance of a defined domain with a reference model as recited in claim 10 wherein said predetermined criteria is at least one of performance, safety, operability, reliability, workload, security, and human performance requirements.

16. The system for testing compliance of a defined domain with a reference model as recited in claim 11 wherein said adjustment unit is configured to effect adjusting at least one model data element automatically.
